(19) United States
(12) Patent Application Publication
(10) Pub. No.: US 2021/0032866 A1
(43) Pub. Date: Feb. 4, 2021

(54) ROOFING SHINGLE

(71) Applicant: Owens Corning Intellectual Capital, LLC, Toledo, OH (US)

(72) Inventors: Jonathan Verhoff, Granville, OH (US); William Smith, Pataskala, OH (US)

(21) Appl. No.: 16/925,274

(22) Filed: Jul. 9, 2020

Related U.S. Application Data
(60) Provisional application No. 62/879,719, filed on Jul. 29, 2019.

(51) Int. Cl. E04D 1/20; B32B 5/02

(52) U.S. Cl. CPC E04D 1/20; E04D 2001/005; B32B 5/02

(57) ABSTRACT

A shingle including a fibrous substrate that reduces or prevents asphalt bleed through is provided. The fibrous substrate has a top surface and a bottom surface opposed to the top surface. Asphalt coating is applied to the top surface of the fibrous substrate. The fibrous substrate includes fibers having a diameter of 3.5 microns to 30 microns and a length of 3.175 mm (⅛ inch) to 50.8 mm (2 inches). In addition, the fibrous substrate has (i) a basis weight of 39.05 g/m² (0.8 lb/100 ft²) to 134.3 g/m² (2.75 lb/100 ft²) and/or (ii) a thickness of 0.381 mm (15 mils) to 1.143 mm (45 mils). A ratio of the amount of asphalt coating on the bottom surface to the amount of asphalt coating on the top surface is from 0:1 to 1:5.

### CROSS-REFERENCE TO RELATED APPLICATIONS

This application claims priority to and the benefit of U.S. Provisional Application No. 62/879,719, filed Jul. 29, 2019, the entire content of which is incorporated by reference herein.

### FIELD

The general inventive concepts relate to roofing materials and, more particularly, to a roofing shingle, that includes a fibrous substrate that reduces or prevents asphalt bleed through.

### BACKGROUND

Asphalt-based roofing materials, such as roofing shingles and roll roofing, are installed on the roofs of buildings to provide protection from the elements and to give the roof an aesthetically pleasing look. As illustrated in FIG. 1, a conventional roofing shingle 1 is typically constructed of a substrate 2, such as a glass fiber mat or an organic felt, an asphalt coating 4 that saturates the substrate 2 and forms a layer of asphalt coating on a top surface and a bottom surface of the substrate 2, a decorative/protective layer of granules 6 applied to the asphalt coating 4 on the top surface of the substrate 2, and a layer of sand or other particulate matter 8 (often referred to as “backdust”) applied to the asphalt coating 4 on the bottom surface of the substrate 2.

Backdust comprises solid particles applied during the manufacturing process to prevent the roofing material from sticking to equipment during production, as well as to prevent the roofing material from sticking together when packaged. The backdust material is typically a particulate material such as sand, talc, or mica. The backdust material is abrasive to manufacturing equipment and generally accelerates equipment wear and tear. In addition, the amount of backdust applied to the roofing material is difficult to control such that more backdust than necessary is typically applied, which leads to increased amounts of loose particulate in the roofing material packaging and waste.

### SUMMARY

The general inventive concepts relate to a roofing shingle that includes a fibrous substrate that reduces or prevents asphalt bleed through. To illustrate various aspects of the general inventive concepts, several exemplary embodiments of the roofing shingle are disclosed.

In one exemplary embodiment, a shingle includes a fibrous substrate and an asphalt coating applied to a top surface of the fibrous substrate. The fibrous substrate has a top surface and a bottom surface opposed to the top surface and includes fibers having a fiber diameter of 3.5 microns to 30 microns and a fiber length of 3.175 mm (⅛ inch) to 50.8 mm (2 inches). In addition, the fibrous substrate has at least one of: (i) a basis weight of 39.05 g/m² (0.8 lb/100 ft²) to 134.3 g/m² (2.75 lb/100 ft²); and (ii) a thickness of 0.381 mm (15 mils) to 1.143 mm (45 mils). A ratio of the amount of asphalt coating on the bottom surface of the fibrous substrate to the amount of asphalt coating on the top surface of the fibrous substrate is from 0:1 to 1:5.

In one exemplary embodiment, a laminated shingle includes an overlay sheet attached to an underlay sheet. Each of the overlay sheet and the underlay sheet include a fibrous substrate and an asphalt coating applied to a top surface of the fibrous substrate. The fibrous substrate has a top surface and a bottom surface opposed to the top surface and includes fibers having a fiber diameter of 3.5 microns to 30 microns and a fiber length of 3.175 mm (⅛ inch) to 50.8 mm (2 inches). In addition, the fibrous substrate has at least one of: (i) a basis weight of 39.05 g/m² (0.8 lb/100 ft²) to 134.3 g/m² (2.75 lb/100 ft²); and (ii) a thickness of 0.381 mm (15 mils) to 1.143 mm (45 mils). A ratio of the amount of asphalt coating on the bottom surface of the fibrous substrate to the amount of asphalt coating on the top surface of the fibrous substrate is from 0:1 to 1:5.

Other aspects, advantages, and features of the general inventive concepts will become apparent to those skilled in the art from the following detailed description, when read in light of the accompanying drawings.

### BRIEF DESCRIPTION OF THE DRAWINGS

The general inventive concepts, as well as embodiments and advantages thereof, are described below in greater detail, by way of example, with reference to the drawings in which:

FIG. 1 is a cross-sectional view of a conventional roofing shingle;

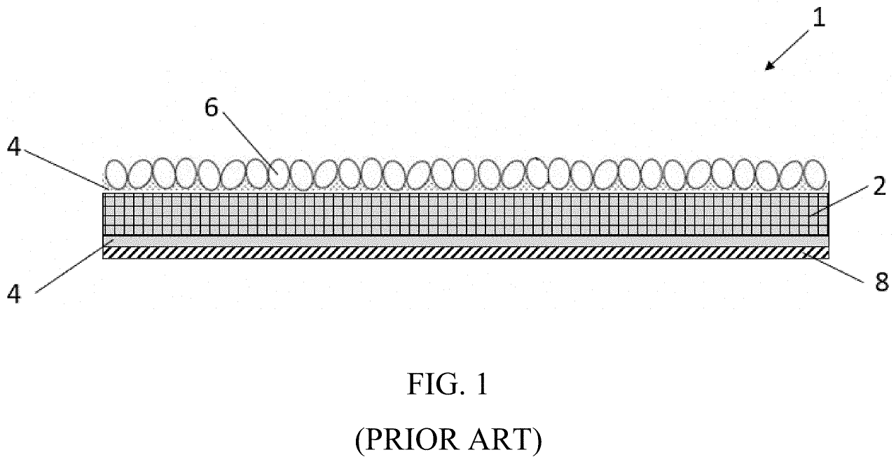

FIG. 2 is a cross-sectional view of an embodiment of a roofing shingle of the present disclosure; and

FIG. 3 is a perspective view of an embodiment of a laminated roofing shingle of the present disclosure.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts relate to roofing materials, particularly roofing shingles, that include a fibrous substrate that reduces or prevents asphalt bleed through. As discussed in further detail below, it has been found that controlling certain parameters of the fibrous substrate affects the extent to which an asphalt coating impregnates the fibrous substrate. Based on these findings, the roofing shingles of the present disclosure provide several advantages over conventional roofing shingles such as utilizing less asphalt coating than conventional shingles, elimination of the backdust layer or other parting material layer while still preventing shingles from sticking together when packaged, and a lighter total weight.

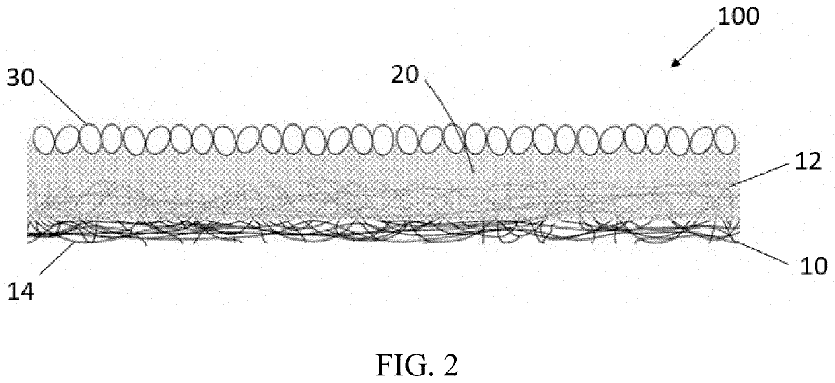

Referring now to FIG. 2, an exemplary embodiment of a roofing shingle 100 of the present disclosure is illustrated. The roofing shingle 100 comprises a fibrous substrate 10 having a top surface 12 and a bottom surface 14 opposed to the top surface, and an asphalt coating 20 applied to the top surface 12 of the fibrous substrate 10. As shown in FIG. 2, the roofing shingle 100 may also include a layer of roofing granules 30 embedded in the asphalt coating 20. The roofing shingle 100 shown in FIG. 2 is an example of a single layer roofing shingle.

The fibrous substrate 10 is constructed to limit the extent to which the asphalt coating 20 impregnates the fibrous substrate 10. As seen in FIG. 2, the asphalt coating 20 does not impregnate the entire thickness of the fibrous substrate 10 (i.e., the asphalt coating 20 does not form a layer on the bottom surface of the fibrous substrate 10). In accordance with the present disclosure, a ratio of the amount of asphalt coating 20 on the bottom surface 14 of the fibrous substrate 10 to the amount of asphalt coating 20 on the top surface 12 of the fibrous substrate 10 is from 0:1 to 1:5. In certain embodiments, the ratio of the amount of asphalt coating 20 on the bottom surface 14 of the fibrous substrate 10 to the amount of asphalt coating 20 on the top surface 12 of the fibrous substrate 10 is from 0:1 to 1:10. In certain embodiments, the bottom surface 14 of the fibrous substrate 10 is free of the asphalt coating 20, as illustrated in FIG. 2. While some amount of asphalt coating 20 may reach the bottom surface 14 of the fibrous substrate 10, the construction of the fibrous substrate 10 limits the extent to which the asphalt coating 20 impregnates the fibrous substrate 10.

The fibrous substrate 10 of the present disclosure generally comprises a plurality of fibers and a binder composition that binds the fibers together. In accordance with the present disclosure, the fibrous substrate 10 comprises fibers having a fiber diameter of 3.5 microns to 30 microns and a fiber length of 3.175 mm (⅛ inch) to 50.8 mm (2 inches). The diameter and the length of the fibers used to form the fibrous substrate 10 may be selected to reduce the void spaces between the fibers that form the fibrous substrate 10, which results in a fibrous substrate 10 that is less permeable and more resistant to asphalt bleed through.

In certain embodiments, the fibrous substrate 10 comprises a blend of fibers having different fiber diameters, different fiber lengths, or both different fiber diameters and different fiber lengths. In certain embodiments, the fibrous substrate 10 comprises a blend of fibers comprising from 1% by weight to 50% by weight of microfibers having an average fiber diameter of 3.5 microns to 7 microns and an average fiber length of 3.175 mm (⅛ inch) to 12.7 mm (½ inch), and from 50% by weight to 99% by weight of base fibers having an average fiber diameter of 8 microns to 15 microns and an average fiber length of 6.35 mm (¼ inch) to 25.4 mm (1 inch), with the weight percentages based on the total weight of the blend of fibers. In certain embodiments, the fibrous substrate 10 comprises a blend of fibers comprising from 5% by weight to 10% by weight of microfibers having an average fiber diameter of 3.5 microns to 7 microns and an average fiber length of 3.175 mm (⅛ inch) to 12.7 mm (½ inch), and from 90% by weight to 95% by weight of base fibers having an average fiber diameter of 8 microns to 15 microns and an average fiber length of 6.35 mm (¼ inch) to 25.4 mm (1 inch), with the weight percentages based on the total weight of the blend of fibers. In certain embodiments, the fibrous substrate 10 comprises a blend of fibers comprising from 25% by weight to 45% by weight of microfibers having an average fiber diameter of 3.5 microns to 7 microns and an average fiber length of 3.175 mm (⅛ inch) to 12.7 mm (½ inch), and from 55% by weight to 75% by weight of base fibers having an average fiber diameter of 8 microns to 15 microns and an average fiber length of 6.35 mm (¼ inch) to 25.4 mm (1 inch), with the weight percentages based on the total weight of the blend of fibers.

In certain embodiments, the fibrous substrate 10 comprises a blend of fibers having an average fiber diameter of 8 microns to 16 microns, and 40% by weight to 60% by weight of the fibers have an average fiber length of 6.35 mm (¼ inch) and 40% by weight to 60% by weight of the fibers have an average fiber length of 19.05 mm (¾ inch), with the weight percentages based on the total weight of the blend of fibers. In certain embodiments, the fibrous substrate 10 comprises a blend of fibers having an average fiber diameter of 8 microns to 16 microns, and 50% by weight of the fibers have an average fiber length of 6.35 mm (¼ inch) and 50% by weight of the fibers have an average fiber length of 19.05 mm (¾ inch), with the weight percentages based on the total weight of the blend of fibers.

In certain embodiments, the fibrous substrate 10 comprises a blend of fibers having an average fiber diameter of 8 microns to 16 microns, and 65% by weight to 85% by weight of the fibers have an average fiber length of 6.35 mm (¼ inch) and 15% by weight to 35% by weight of the fibers have an average fiber length of 19.05 mm (¾ inch), with the weight percentages based on the total weight of the blend of fibers. In certain embodiments, the fibrous substrate 10 comprises a blend of fibers having an average fiber diameter of 8 microns to 16 microns, and 75% by weight of the fibers have an average fiber length of 6.35 mm (¼ inch) and 25% by weight of the fibers have an average fiber length of 19.05 mm (¾ inch), with the weight percentages based on the total weight of the blend of fibers

In certain embodiments, the fibrous substrate 10 comprises fibers having an average fiber diameter of 10 microns to 17 microns and an average fiber length of 6.35 mm (¼ inch) to 38.1 mm (1.5 inches). In certain embodiments, the fibrous substrate 10 comprises fibers having an average fiber diameter of 10 microns to 17 microns and an average fiber length of 6.35 mm (¼ inch) to 31.75 mm (1.25 inches). In certain embodiments, the fibrous substrate 10 comprises fibers having an average fiber diameter of 13 microns to 16 microns and an average fiber length of 19.05 mm (¾ inch). In certain embodiments, the fibrous substrate 10 comprises fibers having an average fiber diameter of 13 microns to 17 microns and an average fiber length of 34.925 mm (1.375 inches).

A variety of fiber types may be used to form the fibrous substrate 10 of the present disclosure. Exemplary fiber types suitable for use in the fibrous substrate 10 include, but are not limited to, glass fibers, synthetic fibers (e.g., polyester fibers, polyethylene fibers, polypropylene fibers, polyethylene terephthalate fibers, polyamide fibers, aramid fibers, polyaramid fibers), mineral fibers, carbon fibers, ceramic fibers, natural fibers (e.g., cellulose fibers, cotton fibers, jute fibers, bamboo fibers, ramie fibers, bagasse fibers, hemp fibers, coir fibers, linen fibers, kenaf fibers, sisal fibers, flax fibers, henequen fibers), or a blend of two or more different fiber types.

In certain embodiments, the fibrous substrate 10 comprises glass fibers. The glass fibers can be made from any type of glass. Exemplary types of glass fibers include, but are not limited to, A-type glass fibers, C-type glass fibers, E-type glass fibers, S-type glass fibers, ECR-type glass fibers (e.g., Advantex® glass fibers commercially available from Owens Corning of Toledo, Ohio), Hiper-tex® glass fibers, wool glass fibers, and combinations thereof.

The glass fibers used to form the fibrous substrate 10 of the present disclosure may have a variety of fiber diameters. In certain embodiments, the glass fibers used to form the fibrous substrate 10 of the present disclosure have an average fiber diameter of 3.5 microns to 30 microns. In certain embodiments, the glass fibers used to form the fibrous substrate 10 of the present disclosure have an average fiber diameter of 10 microns to 17 microns. In certain embodiments, the glass fibers used to form the fibrous substrate 10 of the present disclosure have an average fiber diameter of 13 microns. It is also contemplated that a blend of glass fibers having different fiber diameters, such as a blend of glass microfibers (e.g., average fiber diameter of 3.5 microns to 7 microns) and glass base fibers (e.g., average fiber diameter of 8 microns to 15 microns), may be used to form the fibrous substrate 10 of the present disclosure.

The glass fibers used to form the fibrous substrate 10 of the present disclosure may also have a variety of fiber lengths. In certain embodiments, the glass fibers used to form the fibrous substrate 10 of the present disclosure have an average fiber length of 3.175 mm (⅛ inch) to 25.4 mm (1 inch). In certain embodiments, the glass fibers used to form the fibrous substrate 10 of the present disclosure have an average fiber length of 6.35 mm (¼ inch) to 25.4 mm (1 inch). In certain other embodiments, the glass fibers used to form the fibrous substrate 10 of the present disclosure have an average fiber length of 12.7 mm (0.5 inch) to 25.4 mm (1 inch). In yet other embodiments, the glass fibers used to form the fibrous substrate 10 of the present disclosure have an average fiber length of 19.05 mm (0.75 inch).

It is also contemplated that a blend of glass fibers having different fiber lengths, such as a blend of shorter glass fibers (e.g., average fiber length of 6.35 mm (0.25 inch) to 12.7 mm (0.5 inch)) and longer glass fibers (e.g., average fiber length of 19.05 mm (0.75 inch) to 25.4 mm (1 inch), may be used to form the fibrous substrate 10 of the present disclosure. In certain embodiments, a blend of glass fibers used to form the fibrous substrate 10 of the present disclosure includes 40% by weight to 60% by weight of glass fibers having an average fiber length of 6.35 mm (¼ inch) and 40% by weight to 60% by weight of glass fibers having an average fiber length of 19.05 mm (¾ inch), with the weight percentages based on the total weight of the blend of fibers. In certain embodiments, a blend of glass fibers used to form the fibrous substrate 10 of the present disclosure includes 50% by weight of glass fibers having an average fiber length of 6.35 mm (¼ inch) and 50% by weight of glass fibers having an average fiber length of 19.05 mm (¾ inch), with the weight percentages based on the total weight of the blend of fibers. In certain embodiments, a blend of glass fibers used to form the fibrous substrate 10 of the present disclosure includes 65% by weight to 85% by weight of glass fibers having an average fiber length of 6.35 mm (¼ inch) and 15% by weight to 35% by weight of glass fibers having an average fiber length of 19.05 mm (¾ inch), with the weight percentages based on the total weight of the blend of fibers. In certain embodiments, a blend of glass fibers used to form the fibrous substrate 10 of the present disclosure includes 75% by weight of glass fibers having an average fiber length of 6.35 mm (¼ inch) and 25% by weight of glass fibers having an average fiber length of 19.05 mm (¾ inch), with the weight percentages based on the total weight of the blend of fibers.

As mentioned above, the fibrous substrate 10 of the present disclosure also includes a binder composition that binds the fibers together. Any conventional binder composition used to form nonwoven mats may be used to form the fibrous substrate 10 of the present disclosure. In certain embodiments, the binder composition comprises a binder resin material, a coupling agent, and one or more optional additives. The binder resin may be a thermoset material, a thermoplastic material, or a mixture of a thermoset material and a thermoplastic material. The thermoset material may comprise, for example, an acrylic material, a urea formaldehyde material, or a combination of the two materials. In some exemplary embodiments, the acrylic material is polyacrylic acid, such as low molecular weight polyacrylic acid with a weight average molecular weight at or below 10,000 Daltons. In certain embodiments, the thermoplastic material may include any thermoplastic material having a low glass transition temperature (e.g., below −15° C.), for example, ethylene vinyl acetate.

In certain embodiments, the fibrous substrate 10 comprises from 1% to 30% by weight binder composition, based on the total weight of the fibrous substrate 10. In certain embodiments, the fibrous substrate 10 comprises from 5% to 30% by weight binder composition, including from 10% to 30% by weight binder composition, and also including from 15% to 25% by weight binder composition, based on the total weight of the fibrous substrate 10. As one of skill in the art will appreciate, the amount of binder composition used to form the fibrous substrate 10 may be determined by loss on ignition (LOI).

In certain embodiments, the binder resin may be present in the binder composition in an amount of 90% to 99% based on the total dry weight of the binder composition. In certain other embodiments, the binder resin may be present in the binder composition in an amount of 97% to 99% based on the total dry weight of the binder composition.

The binder composition may further include a coupling agent. It is to be appreciated that the coupling agents described herein are exemplary in nature, and any suitable coupling agent known to those of ordinary skill in the art may be utilized in any of the exemplary embodiments described or otherwise suggested herein. In certain embodiments, the coupling agent, or coupling agents, may be present in the binder composition in an amount of 0.05% to 10% based on the total dry weight of the binder composition. In certain embodiments, the coupling agent, or coupling agents, may be present in the binder composition in an amount of 0.1% to 3% based on the total dry weight of the binder composition. In certain embodiments, the coupling agent, or coupling agents, may be present in the binder composition in an amount of 0.1% to 0.5% based on the total dry weight of the binder composition.

In certain embodiments, at least one of the coupling agents is a silane coupling agent. Suitable silane coupling agents may include silanes containing one or more nitrogen atoms that have one or more functional groups such as amine (primary, secondary, tertiary, and quaternary), amino, imino, amido, imido, ureido, or isocyanato. Suitable silane coupling agents may also include, but are not limited to, aminosilanes, silane esters, vinyl silanes, methacryloxy silanes, epoxy silanes, sulfur silanes, ureido silanes, and isocyanato silanes. Specific, non-limiting examples of silane coupling agents for use in the instant invention include γ-methacryloxypropyl-trimethoxysilane (A-174), γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxysilane (A-188), and methyltrimethoxysilane (A-1630).

The binder composition used to form the fibrous substrate 10 of the present disclosure may optionally include additional components such as, for example, dyes, oils, fillers, colorants, aqueous dispersions, UV stabilizers, lubricants, wetting agents, surfactants, viscosity modifiers, and/or antistatic agents. Such additives may be included in the binder composition in an amount of 0% percent to 10% based on the total dry weight of the binder composition.

In certain embodiments, the binder composition used to form the fibrous substrate 10 of the present disclosure may include water to dissolve or disperse the functional components for application onto the fibers. Water may be added in an amount sufficient to dilute the aqueous binder composition to a viscosity that is suitable for its application to the fibers.

As mentioned above, the fibrous substrate 10 of the present disclosure is constructed to limit the extent to which the asphalt coating 20 impregnates the fibrous substrate 10. It has been found that the basis weight of the fibrous substrate 10 can limit the extent to which the asphalt coating 20 impregnates the fibrous substrate 10. In particular, it has been found that the fibrous substrate 10 of the present disclosure can be formed with a basis weight of 39.05 g/m² (0.8 lb/100 ft²) to 134.3 g/m² (2.75 lb/100 ft²), and more preferably a basis weight of 73.2 g/m² (1.5 lb/100 ft²) to 134.3 g/m² (2.75 lb/100 ft²), to limit the extent to which the asphalt coating 20 impregnates the fibrous substrate 10. In certain embodiments, the fibrous substrate 10 has a basis weight of 39.05 g/m² (0.8 lb/100 ft²) to 134.3 g/m² (2.75 lb/100 ft²), including a basis weight of 48.8 g/m² (1 lb/100 ft²) to 131.83 g/m² (2.7 lb/100 ft²), a basis weight of 73.2 g/m² (1.5 lb/100 ft²) to 131.83 g/m² (2.7 lb/100 ft²), a basis weight of 85.4 g/m² (1.75 lb/100 ft²) to 131.83 g/m² (2.7 lb/100 ft²), and also including a basis weight of 97.6 g/m² (2 lb/100 ft²) to 129.4 g/m² (2.65 lb/100 ft²). Forming the fibrous substrate 10 to have such a basis weight renders the fibrous substrate 10 less permeable and more resistant to asphalt bleed through.

In addition to the fiber diameter, the fiber length, and the basis weight of the fibrous substrate 10, it has also been found that the thickness of the fibrous substrate 10 can limit the extent to which the asphalt coating 20 impregnates the fibrous substrate 10. In particular, it has been found that the fibrous substrate of the present disclosure can be formed with a thickness of 0.381 mm (15 mils) to 1.143 mm (45 mils), and more preferably a thickness of 0.635 mm (25 mils) to 1.016 mm (40 mils), to limit the extent to which the asphalt coating 20 impregnates the fibrous substrate 10. In certain embodiments, the fibrous substrate 10 has a thickness of 0.381 mm (15 mils) to 1.143 mm (45 mils), including a thickness of 0.635 mm (25 mils) to 1.016 mm (40 mils), a thickness of 0.711 mm (28 mils) to 1.016 mm (40 mils), and also including a thickness of 0.889 mm (35 mils) to 1.016 mm (40 mils). Forming the fibrous substrate 10 to have such a thickness makes the fibrous substrate 10 more resistant to asphalt bleed through.

It is also contemplated that the fibrous substrate 10 of the present disclosure may be constructed with more than one of the parameters discussed above (i.e., fiber diameter, fiber length, basis weight, and thickness) to limit the extent to which the asphalt coating 20 impregnates the fibrous substrate 10. In certain embodiments, the fibrous substrate 10 comprises glass fibers having an average fiber diameter of 10 microns to 15 microns, an average fiber length of 12.7 mm (½ inch) to 25.4 mm (1 inch), a basis weight of 85.4 g/m² (1.75 lb/100 ft²) to 131.83 g/m² (2.7 lb/100 ft²), and a thickness of 0.711 mm (28 mils) to 1.016 mm (40 mils). In certain embodiments, the fibrous substrate 10 comprises glass fibers having an average fiber diameter of 13 microns to 15 microns, an average fiber length of 19.05 mm (¾ inch), a basis weight of 129.39 g/m² (2.65 lb/100 ft²) to 131.83 g/m² (2.7 lb/100 ft²), and a thickness of 0.9144 mm (36 mils). In certain embodiments, the fibrous substrate 10 comprises glass fibers having an average fiber diameter of 10 microns to 17 microns, 15% by weight to 35% by weight of the glass fibers (based on the total glass fibers) have an average fiber length of 19.05 mm (¾ inch), 65% by weight to 85% by weight of the glass fibers (based on the total glass fibers) have an average fiber length of 6.35 mm (0.25 inch), a basis weight of 85.4 g/m² (1.75 lb/100 ft²) to 131.83 g/m² (2.7 lb/100 ft²), and a thickness of 0.508 mm (20 mils) to 0.9144 mm (36 mils). In certain embodiments, the fibrous substrate 10 comprises glass fibers having an average fiber diameter of 10 microns to 17 microns, 25% by weight of the glass fibers (based on the total glass fibers) have an average fiber length of 19.05 mm (¾ inch), 75% by weight of the glass fibers (based on the total glass fibers) have an average fiber length of 6.35 mm (0.25 inch), a basis weight of 85.4 g/m² (1.75 lb/100 ft²) to 131.83 g/m² (2.7 lb/100 ft²), and a thickness of 0.508 mm (20 mils) to 0.9144 mm (36 mils).

The fibrous substrate 10 of the present disclosure may have a porosity (as determined in accordance with TAPPI T 460) that is less than conventional substrates used to form conventional shingles. In certain embodiments, the fibrous substrate 10 of the present disclosure has a porosity of 400 ft³/min/ft² to 800 ft³/min/ft², including a porosity of 425 ft³/min/ft² to 775 ft³/min/ft², a porosity of 440 ft³/min/ft² to 700 ft³/min/ft², and also including a porosity of 450 ft³/min/ft² to 675 ft³/min/ft².

The fibrous substrate 10 of the present disclosure may be formed by a variety of processes, including wet-laid processes and dry-laid processes. In certain embodiments, the fibrous substrate 10 is formed by a wet-laid process, which involves forming an aqueous dispersion or slurry of discrete fibers in a mix tank filled with various components (sometimes referred to as white water), such as water, surfactants, viscosity modifiers, defoaming agents, lubricants, biocides, and/or other chemical agents, along with agitation, to form a fiber slurry. It is desirable that the fiber slurry is agitated sufficiently to provide a uniform or nearly uniform dispersion of fibers.

The fiber slurry may then be processed into a wet-laid mat according to any number of conventional methods known in the art. For example, the fiber slurry can be deposited onto a moving screen or conveyor through which most of the water drains, leaving a randomly oriented fiber web. The fiber web may be further dried by a vacuum slot or other drying means. A binder composition may then be applied to the fiber web in a conventional manner, such as by curtain coating, spraying, twin wire dip bath, and the like. Residual water and excess binder composition may then be removed by a vacuum or other water removal means. Finally, the binder-coated fiber product may be dried and cured in one or more ovens. An exemplary temperature range for drying is from 350° F. (177° C.) to 600° F. (316° C.). The dried and cured product is the finished fibrous substrate 10.

As previously mentioned, and as shown in FIG. 2, the roofing shingle 100 of the present disclosure includes an asphalt coating 20 applied to the top surface 12 of the fibrous substrate 10. As used herein, the term “asphalt coating” is defined as any type of bituminous material suitable for use on a roofing material, such as asphalts, tars, pitches, or mixtures thereof. The asphalt coating 20 may comprise either manufactured asphalt produced by refining petroleum or naturally occurring asphalt. The asphalt utilized in the asphalt coating 20 can be oxidized or non-oxidized, blown or unblown. The asphalt coating 20 may be any conventional asphalt used in shingles. The asphalt coating 20 may include various additives and/or modifiers, such as inorganic fillers, mineral stabilizers, organic materials such as polymers, recycled streams, or ground tire rubber. In certain embodiments, the asphalt coating 20 is a filled-asphalt that comprises asphalt and an inorganic filler (e.g., limestone, calcium carbonate, dolomite) or mineral stabilizer.

The asphalt coating 20 can be applied to the top surface 12 of the fibrous substrate 10 in any suitable manner. For example, the asphalt coating 20 can be rolled on, sprayed on, or applied to the top surface 12 of the fibrous substrate 10 by other means.

The amount of asphalt coating 20 applied to the top surface 12 of the fibrous substrate 10 may vary. The amount of asphalt coating 20 may be characterized in terms of basis weight (i.e., mass per area). In certain embodiments, the amount of asphalt coating 20 applied to the top surface 12 of the fibrous substrate 10 is from 976.4 g/m² (20 lb/100 ft²) to 3,173.6 g/m² (65 lb/100 ft²). In certain embodiments, the amount of asphalt coating 20 applied to the top surface 12 of the fibrous substrate 10 is from 976.4 g/m² (20 lb/100 ft²) to 2,929.5 g/m² (60 lb/100 ft²), including from 1,220.6 g/m² (25 lb/100 ft²) to 2,441.2 g/m² (50 lb/100 ft²), from 1,220.6 g/m² (25 lb/100 ft²) to 1,953 g/m² (40 lb/100 ft²), from 1,220.6 g/m² (25 lb/100 ft²) to 1,709 g/m² (35 lb/100 ft²),and also including from 1,367 g/m² (28 lb/100 ft²) to 1,562.4 g/m² (32 lb/100 ft²). The amount of asphalt coating 20 used to form the roofing shingle 100 of the present disclosure may be less than the amount of asphalt coating 20 used to form conventional roofing shingles, which is typically 1,611 g/m² (33 lb/100 ft²) or more. Using less asphalt coating 20 material reduces the cost of manufacturing the roofing shingle 100 of the present disclosure by reducing the amount of asphalt coating 20 material as well as reducing or eliminating the need for a backdust layer or other parting material layer that is typically used to cover the asphalt coating material on the bottom surface of conventional roofing shingles.

In addition to reducing the cost of manufacturing the roofing shingle 100 of the present disclosure, using less asphalt coating 20 and reducing or eliminating the backdust layer also reduces the total weight (i.e., basis weight) of the roofing shingle 100. Conventional asphalt-based roofing shingles typically are formed from shingle sheets having a basis weight of about 2,929.4 g/m² (60 lb/100 ft²) or higher. In certain embodiments, the roofing shingle 100 of the present disclosure is formed from a shingle sheet having a basis weight of 2,197 g/m² (45 lb/100 ft²) to 4,150.1 g/m² (85 lb/100 ft²), which shingle sheet can be used to make, as an example, a laminated shingle having a basis weight of 6,835.4 g/m² (140 lb/100 ft²) to 12,206.1 g/m² (250 lb/100 ft²). In certain embodiments, the roofing shingle 100 of the present disclosure is formed from a shingle sheet having a basis weight of 2,441 g/m² (50 lb/100 ft²) to 3,662 g/m² (75 lb/100 ft²). In certain embodiments, the roofing shingle 100 of the present disclosure is formed from a shingle sheet having a basis weight of 2,441 g/m² (50 lb/100 ft²) to 2,929.5 g/m² (60 lb/100 ft²). In certain embodiments, the roofing shingle 100 of the present disclosure is formed from a shingle sheet having a basis weight of 2,441 g/m² (50 lb/100 ft²) to 2,685.4 g/m² (55 lb/100 ft²). Reducing the total weight of the roofing shingle 100 is advantageous for shingle installers who manually transport bundles of shingles onto the roof.

The extent to which the asphalt coating 20 impregnates the fibrous substrate 10 and reaches the bottom surface of the fibrous substrate 10 may also be quantified using a back-to-back sticking test. An exemplary back-to-back sticking test includes the following steps: cutting 1.875 inch by 6 inch specimens from a sample shingle sheet; stacking two specimens together with the backs of each specimen in contact with each other in a 2 inch area; adding 22.5 lbs. of weight on top of the stacked specimens and placing in a 132° F. over for 24 hours; removing the specimens from the oven, removing the weights from the specimens, and allowing the specimens to cool at 73° F. for 1 hour; testing the specimens in tensile at a 2 inch/minute crosshead speed with a 7 inch gauge length; and recording the maximum breaking force.

Due to the structure of the fibrous substrate 10, the asphalt coating 20 is inhibited from coating the bottom surface 14 of the fibrous substrate 10 such that the roofing shingle 100 of the present disclosure exhibits less than 75 lbf in the back-to-back sticking test. In certain embodiments, the roofing shingle 100 of the present disclosure exhibits less than 50 lbf in the back-to-back sticking test. In certain embodiments, the roofing shingle 100 of the present disclosure exhibits less than 25 lbf in the back-to-back sticking test. In certain embodiments, the roofing shingle 100 of the present disclosure exhibits less than 10 lbf in the back-to-back sticking test. In certain embodiments, the roofing shingle 100 of the present disclosure exhibits 0 lbf in the back-to-back sticking test. The low back-to-back sticking force values (e.g., less than 75 lbf) exhibited by the roofing shingles 100 of the present disclosure also indicates that the roofing shingles 100 are not likely to stick together when packaged for shipment or stick to the shingle manufacturing equipment.

In certain embodiments, the roofing shingle 100 of the present disclosure has an average tear strength of 800 g to 1,400 g. In certain embodiments, the roofing shingle 100 of the present disclosure has an average tear strength of 900 g to 1,400 g. In certain embodiments, the roofing shingle 100 of the present disclosure has an average tear strength of 1,000 g to 1,400 g. In certain embodiments, the roofing shingle 100 of the present disclosure has an average tear strength of 1,200 g to 1,400 g. The tear strength of the roofing shingle may be determined in accordance with ASTM D1922.

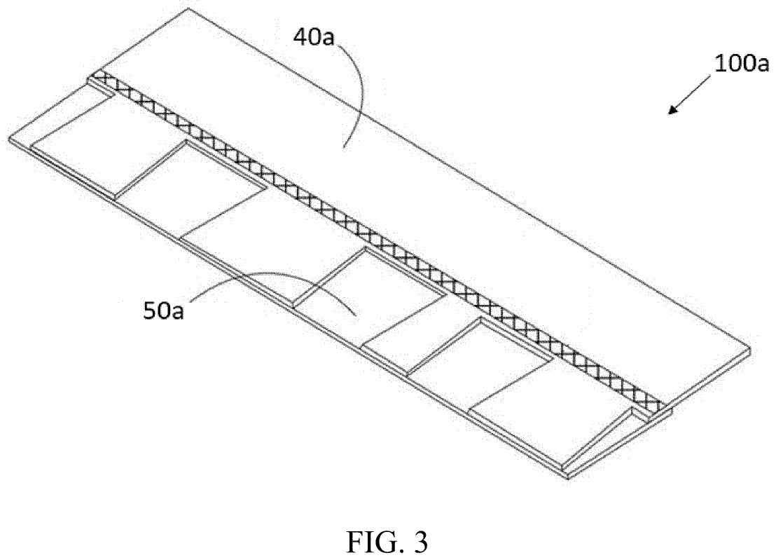

Referring now to FIG. 3, an exemplary embodiment of a laminated roofing shingle 100a of the present disclosure is illustrated. The laminated roofing shingle 100a comprises an overlay sheet 40a disposed on and attached to an underlay sheet 50a. Each of the overlay sheet 40a and the underlay sheet 50a have the same general structure as the single layer roofing shingle 100 shown in FIG. 2 and described above. For example, each of the overlay sheet 40a and the underlay sheet 50a comprise a fibrous substrate having a top surface and a bottom surface opposed to the top surface, and an asphalt coating applied to the top surface of the fibrous substrate. Each of the overlay sheet 40a and the underlay sheet 50a may also include a layer of roofing granules embedded in the asphalt coating. Accordingly, each of the overlay sheet 40a and the underlay sheet 50a may be constructed in accordance with any of the embodiments previously described with respect to the roofing shingle 100 (including the fibrous substrate 10 and the asphalt coating 20) illustrated in FIG. 2.

The roofing shingles 100, 100a of the present disclosure may be manufactured in accordance with conventional shingle manufacturing techniques as known to those of ordinary skill in the art. A common method for the manufacture of asphalt shingles is the production of a continuous sheet of asphalt material followed by a shingle cutting operation which cuts the material into individual shingles. In the production of the asphalt sheet material, hot liquid asphalt coating is applied to a fibrous substrate to form the asphalt sheet material. Subsequently, the asphalt sheet material is passed beneath one or more granule applicators which discharge protective and decorative surface granules onto portions of the asphalt sheet material. The granule covered, asphalt sheet material is then fed to a cutting operation in which the granule covered, asphalt sheet material may be cut into individual shingles, or may be cut into a continuous overlay sheet and a continuous underlay sheet that are subsequently joined together and cut into individual laminated shingles.

### EXAMPLE

In order to more thoroughly describe the general inventive concepts, the following example is provided.

In this example, five shingle samples, including a control sample (i.e., Control A) and four samples according to the present disclosure (i.e., Samples 1A-4A), were produced using five different fibrous substrates (i.e., Control and Samples 1-4) with an asphalt coating applied to the top surface of the fibrous substrates and a layer of granules pressed into the asphalt coating. Various properties of the fibrous substrates and the shingle samples are provided in Tables 1 and 2 below, respectively.

TABLE 1
Fibrous Substrate Properties

| | Substrate | Substrate | Fiber | Fiber | Loss on | | |
|---|---|---|---|---|---|---|---|
| | Basis Weight | Thickness | Diameter | Length | Ignition | | Porosity |
| Sample # | (lb/100 ft²) | (mils) | (micron) | (inch) | (LOI) | Binder Type | (ft³/min/ft²) |
| Control | 1.85 | 24 | 16 | 1.375 | 20% | Urea Formaldehyde | 800 |
| Sample 1 | 2.65 | 36 | 13.5 | 0.75 | 22% | Modified Urea | 650 |
| | | | | | | Formaldehyde/Acrylic | |
| Sample 2 | 1.8 | 28.5 | 11 | 75% at 0.25 inch | 25% | Thermoplastic & | 450 |
| | | | | 25% at 0.75 inch | | Thermoset | |
| Sample 3 | 2.1 | 39 | 13.5 | 0.75 | 22% | Modified Urea | 650 |
| | | | | | | Formaldehyde/Acrylic | |
| Sample 4 | 1.5 | 25 | 13.5 | 0.75 | 25% | Modified Urea | 800 |
| | | | | | | Formaldehyde/Acrylic | |

TABLE 2
Shingle Sample Properties

| | Shingle | Asphalt | Tear Strength | | Back-to- |
|---|---|---|---|---|---|
| | Sheet | Coating | (g) | | Back |
| | Weight | Weight | | Std. | Sticking |
| Sample # | (lb/100 ft²) | (lb/100 ft²) | Average | Dev. | (lbf) |
| Control A | 57.6 | 33.5 | 1,018 | 210 | 142 |
| Sample 1A | 52.5 | 30.3 | 1,394 | 215 | 0 |
| Sample 2A | 53.9 | 31.1 | 1,009 | 122 | 0 |
| Sample 3A | 54.3 | 30.3 | 927 | 178 | 0 |
| Sample 4A | 54.0 | 34.4 | 819 | 137 | 67 |

As seen in Table 2, each of Samples 1A-4A exhibited a much lower back-to-back sticking force (0 lbf for Samples 1A-3A and 67 lbf for Sample 4A) as compared to the Control A shingle (142 lbf). The back-to-back sticking force was tested in accordance with the exemplary back-to-back sticking test described herein. The back-to-back sticking force values listed in Table 2 represent the average of 8 tests for each sample. The lower back-to-back sticking force values for Samples 1A-4A indicate that the fibrous substrates (i.e., Samples 1-4) utilized to construct Samples 1A-4A were effective in limiting or preventing the asphalt coating from bleeding through to the bottom surface of the fibrous substrate. In addition to lower back-to-back sticking force values, Samples 1A-4A also exhibited tear strengths that compared favorably with the Control A shingle. Thus, shingles constructed in accordance with the present disclosure can limit or prevent asphalt coating bleed through, while still retaining a strength that is similar to a conventional shingle.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The roofing shingles of the present disclosure can comprise, consist of, or consist essentially of the essential elements and limitations of the disclosure as described herein, as well as any additional or optional components or limitations described herein or otherwise useful in roofing applications.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the terms “includes” or “including” are used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the Applicant intends to indicate “only A or B but not both” then the term “only A or B but not both” will be employed. Thus, use of the term “or” herein is the inclusive, and not the exclusive use. Furthermore, when the phrase “one or more of A and B” is employed it is intended to mean “only A, only B, or both A and B.” Similarly, when the phrases “at least one of A, B, and C” or “at least one of A, B, C, and combinations thereof” are employed, they are intended to mean “only A, only B, only C, or any combination of A, B, and C” (e.g., A and B; B and C; A and C; A, B, and C).

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the devices, systems, and methods disclosed. It is sought, therefore, to cover all such changes and modifications as fall within the spirit and scope of the general inventive concepts, as described and/or claimed herein, and any equivalents thereof.

What is claimed is:

1. A shingle comprising:
a fibrous substrate having a top surface and a bottom surface opposed to the top surface; and
an asphalt coating applied to the top surface of the fibrous substrate,
wherein the fibrous substrate comprises fibers having a fiber diameter of 3.5 microns to 30 microns and a fiber length of 3.175 mm (⅛ inch) to 50.8 mm (2 inches),
wherein the fibrous substrate has at least one of: (i) a basis weight of 39.05 g/m² (0.8 lb/100 ft²) to 134.3 g/m² (2.75 lb/100 ft²); and (ii) a thickness of 0.381 mm (15 mils) to 1.143 mm (45 mils), and
wherein a ratio of the amount of asphalt coating on the bottom surface of the fibrous substrate to the amount of asphalt coating on the top surface of the fibrous substrate is from 0:1 to 1:5.

2. The shingle of claim 1, wherein a ratio of the amount of asphalt coating on the bottom surface of the fibrous substrate to the amount of asphalt coating on the top surface of the fibrous substrate is from 0:1 to 1:10.

3. The shingle of claim 1, wherein the bottom surface of the fibrous substrate is free of the asphalt coating.

4. The shingle of claim 1, wherein from 976.4 g/m² (20 lb/100 ft²) to 3,173.6 g/m² (65 lb/100 ft²) of the asphalt coating is applied to the top surface of the fibrous substrate.

5. The shingle of claim 1, wherein the shingle has a basis weight of 2,197 g/m² (45 lb/100 ft²) to 4,150.1 g/m² (85 lb/100 ft²).

6. The shingle of claim 1, wherein the fibrous substrate has a basis weight of 87.8 g/m² (1.8 lb/100 ft²) to 132 g/m² (2.7 lb/100 ft²) and a thickness of 0.711 mm (28 mils) to 1.016 mm (40 mils).

7. The shingle of claim 1, wherein the shingle exhibits less than 75 lbf in a back-to-back sticking test.

8. The shingle of claim 1, wherein the fibrous substrate comprises a blend of fibers, wherein the blend of fibers comprises from 1% by weight to 50% by weight of microfibers having an average fiber diameter of 3.5 microns to 7 microns and an average fiber length of 3.175 mm (⅛ inch) to 12.7 mm (½ inch), and from 50% by weight to 99% by weight of base fibers having an average fiber diameter of 8 microns to 15 microns and an average fiber length of 6.35 mm (¼ inch) to 25.4 mm (1 inch), wherein the percentages by weight are based on the total weight of the blend of fibers.

9. The shingle of claim 1, wherein the fibrous substrate comprises glass fibers having an average fiber diameter of 10 microns to 17 microns and an average fiber length of 12.7 mm (½ inch) to 25.4 mm (1 inch).

10. The shingle of claim 1, wherein the fibrous substrate comprises glass fibers having an average fiber diameter of 10 microns to 15 microns, and 65% by weight to 85% by weight of the glass fibers have an average fiber length of 6.35 mm (¼ inch) and 15% by weight to 35% by weight of the glass fibers have an average fiber length of 19.05 mm (¾ inch).

11. The shingle of claim 1, wherein the fibrous substrate comprises a binder composition comprising a thermoset material, a thermoplastic material, and combinations thereof.

12. A laminated shingle comprising:
an overlay sheet attached to an underlay sheet,
wherein each of the overlay sheet and the underlay sheet comprise a fibrous substrate having a top surface and a bottom surface opposed to the top surface, and an asphalt coating applied to a top surface of the fibrous substrate,
wherein the fibrous substrate comprises fibers having a fiber diameter of 3.5 microns to 30 microns and a fiber length of 3.175 mm (⅛ inch) to 50.8 mm (2 inches),
wherein the fibrous substrate has at least one of: (i) a basis weight of 39.05 g/m² (0.8 lb/100 ft²) to 134.3 g/m² (2.75 lb/100 ft²); and (ii) a thickness of 0.381 mm (15 mils) to 1.143 mm (45 mils), and
wherein a ratio of the amount of asphalt coating on the bottom surface of the fibrous substrate to the amount of asphalt coating on the top surface of the fibrous substrate is from 0:1 to 1:5.

13. The laminated shingle of claim 12, wherein a ratio of the amount of asphalt coating on the bottom surface of the fibrous substrate to the amount of asphalt coating on the top surface of the fibrous substrate is from 0:1 to 1:10.

14. The laminated shingle of claim 12, wherein the bottom surface of the fibrous substrate is free of the asphalt coating.

15. The laminated shingle of 12, wherein from 976.4 g/m² (20 lb/100 ft²) to 3,173.6 g/m² (65 lb/100 ft²) of the asphalt coating is applied to the top surface of the fibrous substrate.

16. The laminated shingle of claim 12, wherein the fibrous substrate has a basis weight of 87.8 g/m² (1.8 lb/100 ft²) to 132 g/m² (2.7 lb/100 ft²) and a thickness of 0.711 mm (28 mils) to 1.016 mm (40 mils).

17. The laminated shingle of claim 12, wherein the laminated shingle exhibits less than 75 lbf in a back-to-back sticking test.

18. The laminated shingle of claim 12, wherein the fibrous substrate comprises a blend of fibers, wherein the blend of fibers comprises from 1% by weight to 50% by weight of microfibers having an average fiber diameter of 3.5 microns to 7 microns and an average fiber length of 3.175 mm (⅛ inch) to 12.7 mm (½ inch), and from 50% by weight to 99% by weight of base fibers having an average fiber diameter of 8 microns to 15 microns and an average fiber length of 6.35 mm (¼ inch) to 25.4 mm (1 inch), wherein the percentages by weight are based on the total weight of the blend of fibers.

19. The laminated shingle of claim 12, wherein the fibrous substrate comprises glass fibers having an average fiber diameter of 10 microns to 17 microns and an average fiber length of 6.35 mm (¼ inch) to 34.925 mm (1.375 inch).

20. The laminated shingle of claim 12, wherein the fibrous substrate comprises glass fibers having an average fiber diameter of 10 microns to 15 microns, and 65% by weight to 85% by weight of the glass fibers have an average fiber length of 6.35 mm (¼ inch) and 15% by weight to 35% by weight of the glass fibers have an average fiber length of 19.05 mm (¾ inch).
